(19) United States
(12) Patent Application Publication
(10) Pub. No.: US 2026/0070838 A1
(43) Pub. Date: Mar. 12, 2026

(54) ETCHING DEVICE AND WINDOWMANUFACTURING METHOD

(71) Applicant: Samsung Display Co., LTD., Yongin-si (KR)

(72) Inventors: KANG DUK CHOI, Yongin-si (KR); HYUNCHUL KIM, Yongin-si (KR); JUNHEE BAE, Yongin-si (KR); BYOUNGYUL SHIM, Yongin-si (KR); SEUNGPYO HONG, Yongin-si (KR)

(21) Appl. No.: 19/194,997

(22) Filed: Apr. 30, 2025

(30) Foreign Application Priority Data
Sep. 6, 2024 (KR) 10-2024-0121610

(51) Int. Cl. C03C 15/00

(52) U.S. Cl. CPC C03C 15/00

(57) ABSTRACT

An etching device includes a stage on which a target substrate is disposed, a nozzle part, and a magnetic layer including a first and second magnetic parts spaced apart from each other in a first direction. The first magnetic part includes a first base portion adjacent to the stage and a first protruding portion extending from the first base portion in the first direction and spaced apart from the stage. The second magnetic part includes a second base portion adjacent to the stage and a second protruding portion extending from the second base portion in a direction opposite to the first direction and spaced apart from the stage. A distance from the stage to the first protruding portion in a thickness direction increases in the first direction. A distance from the stage to the second protruding portion in the thickness direction increases in the direction opposite to the first direction.

This application claims priority to Korean Patent Application No. 10-2024-0121610, filed on Sep. 6, 2024, and all the benefits accruing therefrom under 35 U.S. C. § 119, the content of which in its entirety is herein incorporated by reference.

### BACKGROUND

The present disclosure herein relates to an etching device and a window manufacturing method, and more particularly, to an etching device and a window manufacturing method with which it is possible to manufacture a foldable window.

Display devices include a display region which is activated in response to an electrical signal. Display devices may sense an input applied from the outside through a display region, and at the same time, may provide information to a user by displaying various images. Recently, as display devices with various shapes are being developed, research is being actively conducted particularly on foldable display devices, and a method for effectively etching an ultra-thin glass (UTG) is increasingly demanded so as to achieve foldable properties.

### SUMMARY

The present disclosure provides an etching device with which it is possible to manufacture a window with a foldable property and improved reliability.

The present disclosure also provides a window manufacturing method with which it is possible to manufacture a window with a foldable property and improved reliability through a simple process.

An embodiment of the invention provides an etching device including a stage on which a target substrate is disposed, a nozzle part opposed to the stage with the target substrate therebetween, and configured to spray an etching solution toward the stage, and a magnetic layer disposed between the target substrate and the nozzle part, and including a first magnetic part and a second magnetic part spaced apart from the first magnetic part in a first direction, wherein the first magnetic part includes a first base portion adjacent to the stage and a first protruding portion extending from the first base portion in the first direction and spaced apart from the stage, the second magnetic part includes a second base portion adjacent to the stage and a second protruding portion extending from the second base portion in a direction opposite to the first direction and spaced apart from the stage, a distance from the stage to the first protruding portion in a thickness direction of the etching device progressively increases in the first direction, and a distance from the stage to the second protruding portion in the thickness direction progressively increases in the direction opposite to the first direction.

In an embodiment, the etching device may further include a fixing part disposed on the stage and configured to fix the target substrate.

In an embodiment, the stage may include a magnetic material.

In an embodiment, the etching solution may include a fluorine-containing compound.

In an embodiment, the magnetic layer may include a rubber magnet.

In an embodiment, the stage and the magnetic layer may each independently have a thickness of about 0.5 millimeters (mm) to about 6 mm.

In an embodiment, a spaced distance between the first magnetic part and the second magnetic part in the first direction may be about 5 mm to about 15 mm.

In an embodiment, a width of the first protruding portion in the first direction and a width of the second protruding portion in the first direction may each be independently about 3 mm to about 10 mm.

In an embodiment, the first base portion may include a first base lower surface adjacent to the stage and a first base upper surface opposed to the first base lower surface, the first protruding portion may include a first protruding upper surface extending from the first base upper surface in the first direction and a first protruding lower surface connecting the first base lower surface and the first protruding upper surface, the second base portion may include a second base lower surface adjacent to the stage and a second base upper surface opposed to the second base lower surface, and the second protruding portion may include a second protruding upper surface extending from the second base upper surface in the direction opposite to the first direction and a second protruding lower surface connecting the second base lower surface and the second protruding upper surface.

In an embodiment, at least one of the first protruding lower surface or the second protruding lower surface may have a downward convex shape when viewed in a second direction crossing the first direction and the thickness direction.

In an embodiment, at least one of the first protruding lower surface or the second protruding lower surface may have a straight line shape when viewed in a second direction crossing the first direction and the thickness direction.

In an embodiment, the etching device may further include a mask which is disposed between the magnetic layer and the nozzle part, and in which an opening overlapping the nozzle part in the thickness direction is defined.

In an embodiment, the mask may include a magnetic material.

In an embodiment, a width of the opening in the first direction may be substantially the same as a spaced distance between the first magnetic part and the second magnetic part in the first direction.

In an embodiment, the mask may include a first mask portion to which a distance from the stage in the thickness direction progressively increases in the first direction, and a second mask portion which is spaced apart from the first mask portion in the first direction with the opening therebetween and to which a distance from the stage in the thickness direction progressively increases in the direction opposite to the first direction, and each of the first mask portion and the second mask portion may not overlap the magnetic layer in the thickness direction.

In an embodiment, a difference between a maximum spaced distance and a minimum spaced distance, among the spaced distances between the first mask portion and the stage in the thickness direction, may be about 0.5 mm to about 3 mm, and a difference between a maximum spaced distance and a minimum spaced distance, among the spaced distances between the second mask portion and the stage in the thickness direction, may be about 0.5 mm to about 3 mm.

In an embodiment of the invention, a window manufacturing method includes providing a target substrate on a stage and providing a nozzle part opposed to the stage with the target substrate therebetween, disposing, between the target substrate and the nozzle part, a magnetic layer including a first magnetic part and a second magnetic part spaced apart from the first magnetic part in a first direction, and providing, by using the nozzle part, an etching solution onto the target substrate through a spaced part defined as a space between the first magnetic part and the second magnetic part, wherein the first magnetic part includes a first base portion disposed on the target substrate and a first protruding portion extending from the first base portion in the first direction and spaced apart from the stage, the second magnetic part includes a second base portion disposed on the target substrate and a second protruding portion extending from the second base portion in a direction opposite to the first direction and spaced apart from the stage, a distance from the stage to the first protruding portion in a thickness direction progressively increases in the first direction, and a distance from the stage to the second protruding portion in the thickness direction progressively increases in the direction opposite to the first direction.

In an embodiment, the first base portion and the second base portion may each be directly disposed on the target substrate.

In an embodiment, the window manufacturing method may further include, between the disposing of the magnetic layer and the providing of the etching solution onto the target substrate, disposing, between the magnetic layer and the nozzle part, a mask in which an opening overlapping the nozzle part in the thickness direction is defined.

In an embodiment, the stage and the mask may each include a magnetic material.

### BRIEF DESCRIPTION OF THE FIGURES

The accompanying drawings are included to provide a further understanding of the invention, and are incorporated in and constitute a part of this specification. The drawings illustrate embodiments of the invention and, together with the description, serve to explain principles of the invention. In the drawings:

FIGS. 1A to 1C are each a perspective view of a display device according to an embodiment of the invention;

FIG. 2 is an exploded perspective view of a display device according to an embodiment of the invention;

FIGS. 3A and 3B are each a cross-sectional view of an electronic apparatus taken along line I-I′ of FIG. 2;

FIG. 4 is a perspective view of an etching device according to an embodiment of the invention;

FIG. 5 is an exploded perspective view of the etching device of FIG. 4;

FIGS. 6 and 7 are each a cross-sectional view of an etching device taken along line II-II′ of FIG. 4;

FIG. 8 is a perspective view of an etching device according to another embodiment of the invention;

FIG. 9 is an exploded perspective view of the etching device of FIG. 8;

FIG. 10 is a cross-sectional view of an etching device taken along line III-III′ of FIG. 8;

FIG. 11 is a cross-sectional view of an etching device according to an embodiment of the invention;

FIG. 12 is a flowchart of a window manufacturing method according to an embodiment of the invention;

FIGS. 13 to 17 each illustrate a part of a window manufacturing method according to an embodiment of the invention;

FIG. 18 is a perspective view of a target substrate according to an embodiment of the invention;

FIG. 19 is a perspective view of a window according to an embodiment of the invention; and

FIG. 20 is a cross-sectional view of a window taken along line IV-IV′ of FIG. 19.

### DETAILED DESCRIPTION

In this specification, it will be understood that when an element (or a region, a layer, a portion, or the like) is referred to as being “on”, “connected to” or “coupled to” another element, it can be directly disposed on/connected to/coupled to the other element or layer or intervening elements may be disposed therebetween.

Like numerals or symbols refer to like elements throughout. Also, in the drawings, the thicknesses, ratios, and dimensions of the elements are exaggerated for effective description of the technical contents. The term “and/or” includes all of one or more combinations which can be defined by related elements.

Although the terms “first”, “second”, etc. may be used to describe various elements, these elements should not be limited by these terms. These terms are only used to distinguish one element from another element. For example, a first element may be referred to as a second element, and similarly, a second element may also be referred to as a first element without departing from the scope of the present disclosure. The singular forms include the plural forms as well, unless the context clearly indicates otherwise.

Also, terms of “below”, “on lower side”, “above”, “on upper side”, or the like may be used to describe the relationships of the elements illustrated in the drawings. These terms have relative concepts and are described on the basis of the directions indicated in the drawings.

It will be understood that the term “includes” or “comprises”, when used in this specification, specifies the presence of stated features, integers, steps, operations, elements, components, or a combination thereof, but does not preclude the presence or addition of one or more other features, integers, steps, operations, elements, components, or combinations thereof.

In this specification, when an element is referred to as being “directly disposed on” another layer, film, region, board, etc., there are no intervening layer, film, region, board, etc., present. For example, the wording “directly disposed” means that an additional member such as an adhesive member, or the like may not be used between two layers or two members.

Unless otherwise defined, all terms (including technical and scientific terms) used herein have the same meaning as commonly understood by one of ordinary skills in the art to which the present disclosure belongs. Also, terms, such as those defined in commonly used dictionaries, should be interpreted as having a meaning that is consistent with their meaning in the context of the relevant art and should not be interpreted in an idealized or overly formal sense unless expressly so defined herein.

“About” or “substantially the same” as used herein is inclusive of the stated value and means within an acceptable range of deviation for the particular value as determined by one of ordinary skill in the art, considering the measurement in question and the error associated with measurement of the particular quantity (i.e., the limitations of the measurement system). For example, “substantially the same” can mean within one or more standard deviations, or within ±10%, 5% or 2% of the stated value. Hereinafter, embodiments of the invention will be described with reference to the accompanying drawings.

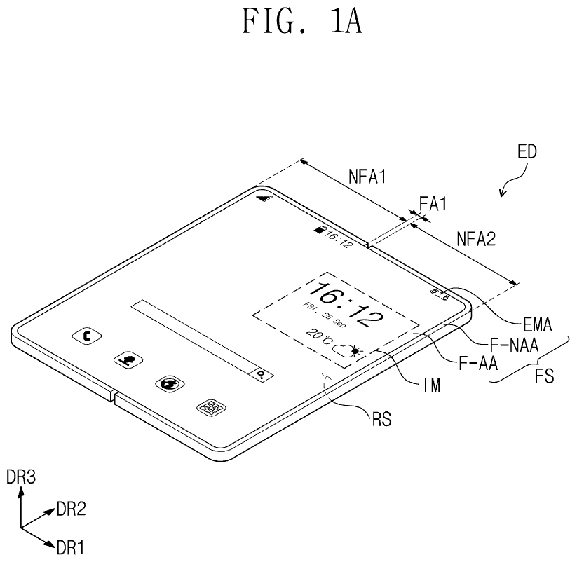

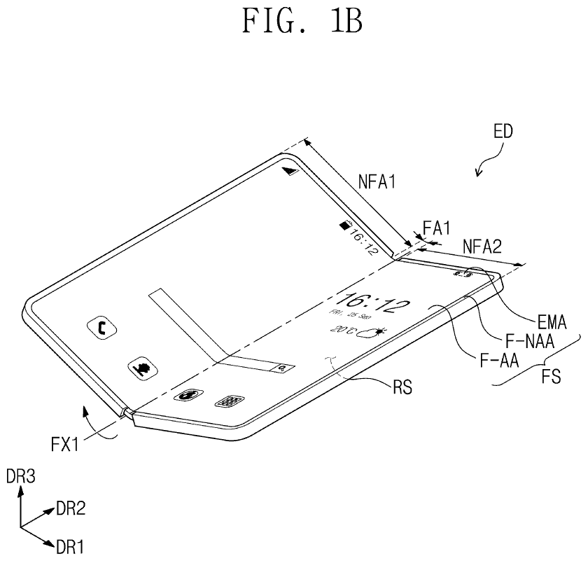

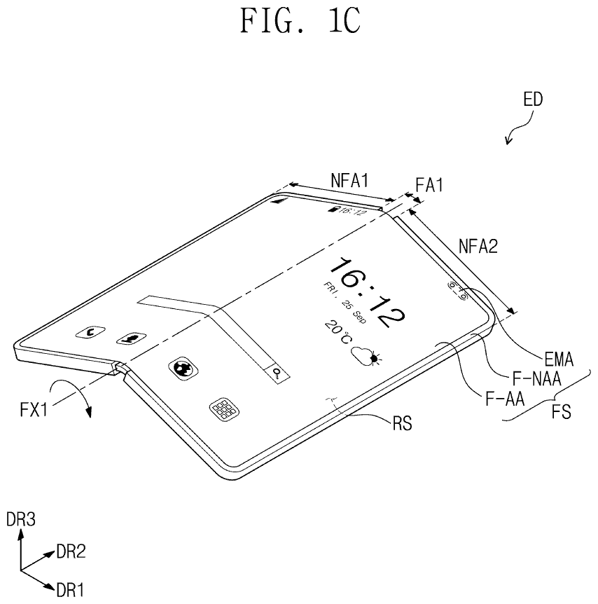

FIGS. 1A to 1C are perspective views of a display device according to an embodiment of the invention. FIG. 1A illustrates an unfolded state, and FIGS. 1B and 1C illustrate a folded state.

FIGS. 1A to 1C illustrate that a display device ED is a foldable display device that changes into a folded shape, but an embodiment of the invention is not limited thereto. The display device ED according to an embodiment may be a flexible display device that may change in shape by being bent or rolled.

The display device ED according to an embodiment may include a display surface FS defined by a first direction DR1 and a second direction DR2 crossing the first direction DR1. The display device ED may provide an image IM through the display surface FS. The display device ED according to an embodiment may display, toward a third direction DR3, the image IM on the display surface FS that is parallel to each of the first direction DR1 and the second direction DR2.

The display surface FS of the display device ED according to an embodiment may include an active region F-AA and a peripheral region F-NAA. The active region F-AA may be activated in response to an electrical signal. The display device ED according to an embodiment may display the image IM through the active region F-AA. In addition, various types of external inputs may be sensed in the active region F-AA. The peripheral region F-NAA is adjacent to the active region F-AA. The peripheral region F-NAA may have a predetermined color. The peripheral region F-NAA may surround the active region F-AA. Accordingly, a shape of the active region F-AA may be substantially defined by the peripheral region F-NAA. However, this is exemplarily illustrated, and the peripheral region F-NAA may be disposed adjacent to only one side of the active region F-AA, or may be omitted. The display device ED according to an embodiment of the invention may include the active region with various shapes, and the invention is not limited to any one embodiment.

A sensing region EMA may be included in the active region F-AA. Various electronic modules may be disposed in the sensing region EMA. For example, the electronic module may include at least one of a camera module, a speaker, a light-detecting sensor, or a heat-detecting sensor. The sensing region EMA may detect an external subject received through the display surface FS, or may provide a sound signal, such as a voice, to the outside through the display surface FS. The electronic module may include a plurality of components, and the invention is not limited to any one embodiment.

The sensing region EMA may be surrounded by the active region F-AA and the peripheral region F-NAA. However, an embodiment of the invention is not limited thereto, and the sensing region EMA may be disposed inside the active region F-AA. The invention is not limited to any one embodiment. One sensing region EMA is exemplarily illustrated in FIG. 1A, etc., but the number of the sensing region EMA is not limited thereto.

The sensing region EMA may be a portion of the active region F-AA. Accordingly, the display device ED may also display a video in the sensing region EMA. When the electronic modules disposed in the sensing region EMA become deactivated, the sensing region EMA may serve as a display surface and display the video or the image IM (see FIG. 1).

A rear surface RS of the display device ED according to an embodiment may be a surface facing the display surface FS. In an embodiment, the rear surface RS is an external surface of the display device ED, and may not display the video or the image IM (see FIG. 1). However, an embodiment of the invention is not limited thereto, and the rear surface RS may serve as a second display surface in which the video or the image IM (see FIG. 1) is displayed. In addition, although not illustrated separately, the display device ED according to an embodiment may further include a sensing region disposed on the rear surface RS. A camera, a speaker, a light-detecting sensor, or the like may also be disposed in the sensing region disposed on the rear surface RS.

The display device ED may include a folding region FA and non-folding regions NFA1 and NFA2. The display device ED may include a plurality of non-folding regions NFA1 and NFA2. The display device ED according to an embodiment may include a first non-folding region NFA1 and a second non-folding region NFA2 which are disposed with the folding region FA therebetween. Meanwhile, FIGS. 1A to 1C illustrate an embodiment in which the display device ED includes one folding region FA, but an embodiment of the invention is not limited thereto. A plurality of folding regions may be defined in the display device ED. However, an embodiment of the invention is not limited thereto, and the display device ED according to an embodiment may be folded with respect to a plurality of folding axes, and may thus be folded such that portions of the display surface FS face each other. The number of the folding axes and the number of the non-folding regions corresponding thereto are not particularly limited.

Referring to FIGS. 1B and 1C, the display device ED according to an embodiment may be folded with respect to a folding axis FX1 extending in one direction. The folding axis FX1 illustrated in FIGS. 1B and 1C may be a virtual axis extending in the second direction DR2, and the folding axis FX1 may be parallel to a long-side direction of the display device ED. However, an embodiment of the invention is not limited thereto, and an extending direction of the folding axis FX1 is not limited to the second direction DR2.

The folding axis FX1 may extend along the second direction DR2 on the display surface FS or may extend along the second direction DR2 under the rear surface RS. Referring to FIG. 1B, in an embodiment, the first non-folding region NFA1 and the second non-folding region NFA2 may face each other, and the display device ED may be in-folded such that the display surface FS is not exposed to the outside. In addition, referring to FIG. 1C, the display device ED according to an embodiment may be folded with respect to the folding axis FX1 and changed into an out-folded state in which one region of the rear surface RS overlapping the first non-folding region NFA1 and the other region overlapping the second non-folding region NFA2 face each other.

In an embodiment, the display device ED may be configured such that an unfolding operation and an in-folding or out-folding operation are mutually repeated, but an embodiment of the invention is not limited thereto. In an embodiment, the display device ED may be configured to select any one among the unfolding operation, the in-folding operation and the out-folding operation.

Meanwhile, FIGS. 1A to 1C illustrate that the display device ED is folded with respect to the folding axis FX1 that is parallel to the long side of the display device ED, but an embodiment of the invention is not limited thereto. The display device according to an embodiment may be folded with respect to a folding axis that is parallel to a short side of the display device.

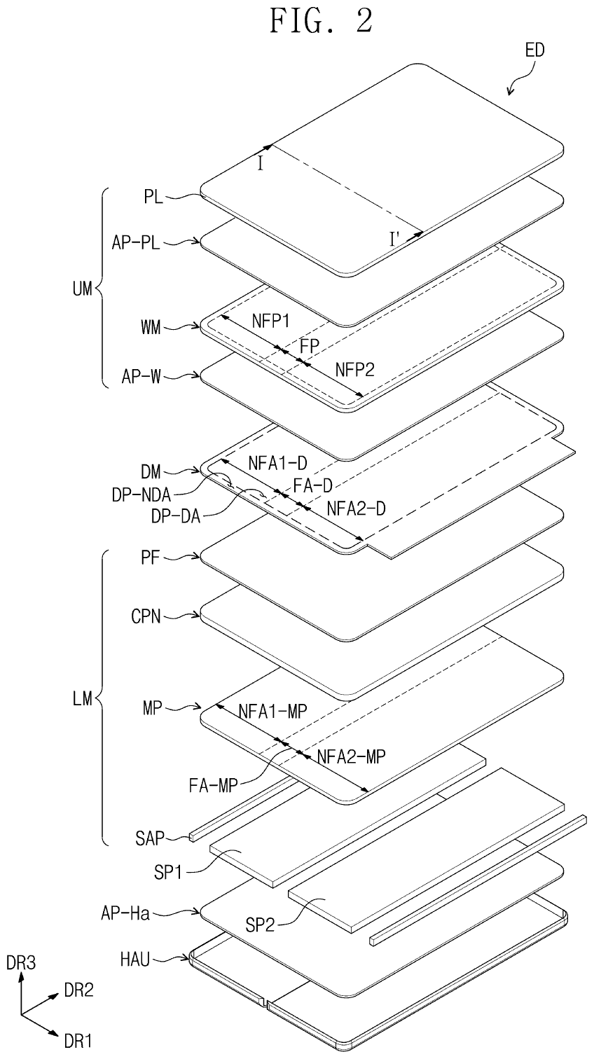

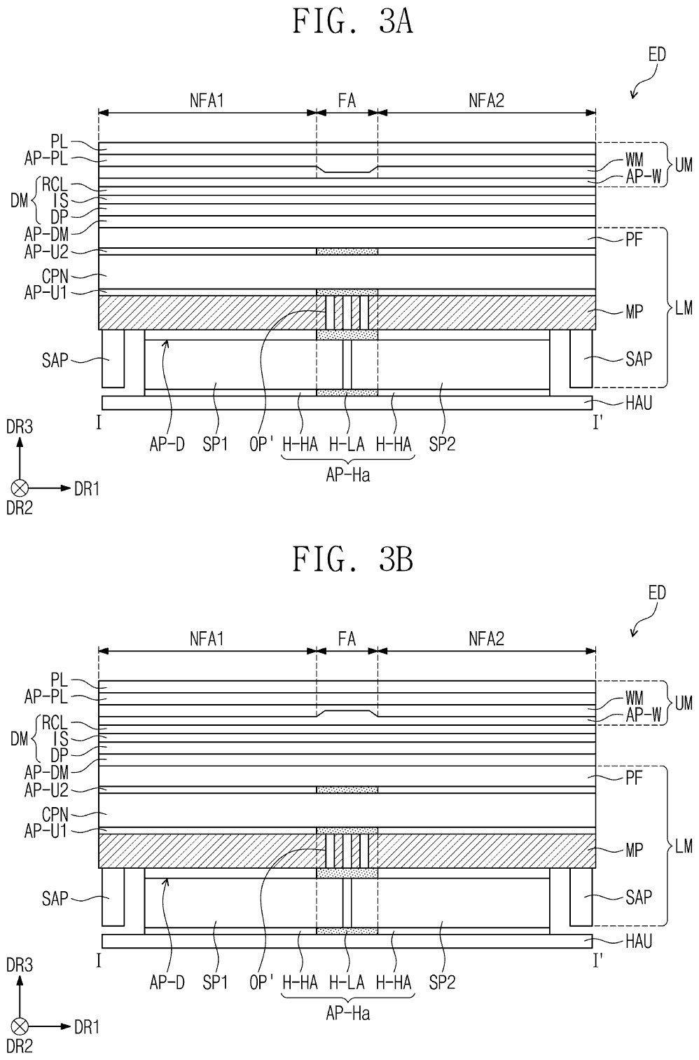

FIG. 2 is an exploded perspective view of a display device according to an embodiment, and FIG. 3 is a cross-sectional view of a display device according to an embodiment. FIG. 2 exemplarily illustrates an exploded perspective view of the display device according to an embodiment illustrated in FIG. 1A. FIGS. 3A and 3B are each a cross-sectional view taken along line I-I′ of FIG. 2. Unlike a display device illustrated in FIG. 3A, a display device illustrated in FIG. 3B has a recessed pattern that is formed in a lower surface of a window.

Referring to FIGS. 2 to 3B together, a display device ED according to an embodiment may include a display module DM, an upper module UM disposed on the display module DM, and a lower module LM disposed under the display module DM. Meanwhile, in this specification, the upper module UM may be referred to as a protection member, and the lower module LM may be referred to as a support member.

The upper module UM is disposed on the display module DM and may serve as a protection part which protects the display module DM from an external impact, etc., or as an optical part which prevents reflection of external light or increases light extraction efficiency.

The upper module UM may include a window WM disposed on the display module DM, a protective layer PL disposed on the window WM, and a protective layer adhesive layer AP-PL disposed between the window WM and the protective layer PL.

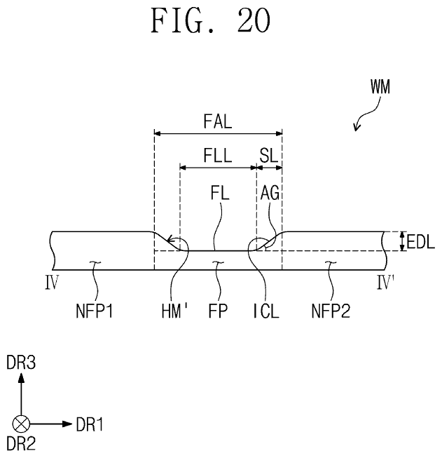

The window WM may cover the entire exterior of the display module DM. The window WM may have a shape corresponding to a shape of the display module DM. In the display device ED according to an embodiment, the window WM may include an optically transparent insulating material. The window WM may be a glass substrate or a polymer substrate. For example, the window WM may be a tempered glass substrate that is subjected to a strengthening treatment. In the window WM according to the invention, stepped portions between a folding portion FP corresponding to the folding region FA and non-folding portions NFP1 and NFP2 corresponding to the non-folding regions NFA1 and NFA2, respectively, may be formed to contribute to a folding property of the display device ED. The stepped portions between the folding portion FP and the non-folding portions NFP1 and NFP2 of the window WM according to the invention may be formed by forming a recessed pattern in an upper surface of the window WM as illustrated in FIG. 3A, or may be formed by forming a recessed pattern in a lower surface of the window WM as illustrated in FIG. 3B. Boundaries between the folding portion FP and the non-folding portions NFP1 and NFP2 of the window WM according to the invention may be formed to be gently inclined, thereby improving a distortion phenomenon that would occur between a display region DP-DA and a non-display region DP-NDA of the display device ED. A detailed shape of the window WM will be described later with reference to FIGS. 19 and 20.

The upper module UM may further include a window adhesive layer AP-W disposed under the window WM. The window adhesive layer AP-W may be disposed between the display module DM and the window WM. The window adhesive layer AP-W may be an optically clear adhesive (OCA) film or an optically clear adhesive resin (OCR) layer. The window adhesive layer AP-W may be omitted in an embodiment.

In an embodiment, the protective layer PL may be disposed on the window WM and may protect the window WM from the external environment. Since the protective layer PL is transparent, information of the image IM (see FIG. 1) provided from the display module DM may be identified even when the protective layer PL is disposed. The protective layer PL may be exposed as an uppermost surface of the display device ED, and thus the protective layer PL may be damaged depending on the use of the display device ED.

The protective layer PL may have an optical property having transmittance of about 90% or more in a visible light range, and having a haze value of less than about 1%. The protective layer PL may include a polymer film. In addition, the protective layer PL may have the polymer film as a base layer, and may further include, on the base layer, a function layer such as a hard coating layer, an anti-fingerprint coating layer, and an antistatic coating layer. Meanwhile, the protective layer PL used in the display device ED according to an embodiment may have flexibility.

The protective layer PL according to an embodiment may be a polymer film including at least one polymer resin among polyethylene terephthalate (PET), polybutylene terephthalate, (PBT), polyethylene naphthalene (PEN), polycarbonate (PC), polymethylmethacrylate (PMMA), polystyrene (PS), polyvinylchloride (PVC), polyether sulfone (PES), polypropylene, (PP), polyamide (PA), modified polyphenylene ether (m-PPO), polyoxymethylene (POM), polysulfone (PSU), polyphenylene sulfide (PPS), polyimide (PI), polyethyleneimine (PEI), polyether ether ketone (PEEK), polyamide imide (PAI), polyarylate (PAR) and thermoplastic polyurethane (TPU).

For example, the protective layer PL according to an embodiment may be a polyethylene terephthalate (PET) film or thermoplastic polyurethane (TPU) film. In addition, the protective layer PL may be a polyethylene terephthalate (PET) film having no phase delay.

In the display device ED according to an embodiment, the protective layer adhesive layer AP-PL may be disposed between the window WM and the protective layer PL. The protective layer adhesive layer AP-PL may be an optically clear adhesive layer. The protective layer adhesive layer AP-PL may be bonded to the window WM, and may fix the protective layer PL to the window WM.

The display device ED according to an embodiment may include a housing HAU for accommodating the display module DM and the lower module LM. The housing HAU may be coupled to the window WM. In addition, the housing HAU may include a hinge structure for facilitating folding or bending. The hinge structure may be disposed corresponding to the folding region FA.

The display device ED according to an embodiment may include a housing adhesive layer AP-Ha. The housing adhesive layer AP-Ha may perform a function for fixing the lower module LM to the housing HAU. Meanwhile, the housing adhesive layer AP-Ha may include a folding adhesive portion H-LA corresponding to the folding region FA and a non-folding adhesive portion H-HA corresponding to the non-folding regions NFA1 and NFA2. Meanwhile, the housing adhesive layer AP-Ha may be an adhesive member for coupling the lower module LM and the housing HAU, and may serve as an electromagnetic shielding layer or a heat dissipation layer.

The display module DM included in the display device ED according to an embodiment may be a component for generating an image, and sensing an input applied from the outside. The display module DM according to an embodiment may include a display panel DP and an input sensor IS disposed on the display panel DP. In addition, the display module DM according to an embodiment may further include an optical layer RCL disposed on the input sensor IS.

The display panel DP may be a component for substantially generating an image. The display panel DP may be an emissive display panel, and for example, the display panel DP may be an organic light-emitting display panel, an inorganic light-emitting display panel, a quantum-dot display panel, a micro-LED display panel, or a nano-LED display panel. The display panel DP may be referred to as a display layer.

The input sensor IS may be disposed on the display panel DP. The input sensor IS may sense an external input applied from the outside. The external input may be a user's input. The user's input may include various types of external inputs such as a part of the user body, light, heat, a pen, or pressure.

The input sensor IS may be formed on the display panel DP through a continuous process. In this case, it may be described that the input sensor IS is directly disposed on the display panel DP. The wording “directly disposed” may mean that a third component is not disposed between the input sensor IS and the display panel DP. That is, an additional adhesive member may not be disposed between the input sensor IS and the display panel DP. Alternatively, the input sensor IS and the display panel DP may be coupled to each other through an adhesive member. The adhesive member may include a typical adhesive or bonding agent.

The optical layer RCL may be disposed on the input sensor IS. The optical layer RCL may be an anti-reflection layer for reducing reflectance for external light incident from the outside. The optical layer RCL may be formed on the input sensor IS through a continuous process. The optical layer RCL may include a polarizing plate or include a color filter layer. Alternatively, the optical layer RCL may include a pigment, dye, or the like and thus absorb light in a particular wavelength range. When the optical layer RCL includes the color filter layer, the color filter layer may include a plurality of color filters disposed in a predetermined arrangement. For example, the color filters may be arranged in consideration of emission colors of pixels included in the display panel DP. In addition, the optical layer RCL may further include a division pattern for dividing pixels, or the like of the display panel DP. The division pattern may include a black pigment or dye. In an embodiment of the invention, the optical layer RCL may be omitted.

The display region DP-DA and the non-display region DP-NDA may be defined in the display module DM according to an embodiment. The display region DP-DA may be defined as a region for displaying an image provided from the display module DM.

The non-display region DP-NDA may be adjacent to the display region DP-DA. For example, the non-display region DP-NDA may surround the display region DP-DA. However, this is exemplarily illustrated, and the non-display region DP-NDA may be defined to have various shapes. The invention is not limited to any one embodiment. According to an embodiment, the display region DP-DA of the display module DM may correspond to at least a portion of the active region F-AA (see FIG. 1A).

In the display device ED according to an embodiment, the display module DM may include a folding display portion FA-D and non-folding display portions NFA1-D and NFA2-D. The folding display portion FA-D may be a portion corresponding to the folding region FA (see FIG. 1A), and the non-folding display portions NFA1-D and NFA2-D may be portions corresponding to the non-folding regions NFA1 and NFA2 (see FIG. 1A), respectively.

The folding display portion FA-D may correspond to a portion that is folded or bent with respect to the folding axis FX1 (see FIG. 1B). The display module DM may include a first non-folding display portion NFA1-D and a second non-folding display portion NFA2-D, and the first non-folding display portion NFA1-D and the second non-folding display portion NFA2-D may be spaced apart from each other with the folding display portion FA-D therebetween.

Meanwhile, the display device ED according to an embodiment may further include a module adhesive layer AP-DM disposed between the display module DM and the lower module LM. The module adhesive layer AP-DM may be an optically clear adhesive (OCA) film or an optically clear adhesive resin (OCR) layer.

In the display device ED according to an embodiment, the lower module LM may include a support plate MP and adhesive layers AP-U1, AP-U2, and AP-D disposed on/over and under the support plate MP. In addition, in an embodiment, the lower module LM may further include at least one among support parts SP1 and SP2, a charging part SAP, a module protective layer PF, and a buffer layer CPN. For example, the display device ED according to an embodiment may include the support plate MP which is disposed under the display module DM, the module protective layer PF and the buffer layer CPN which are disposed between the support plate MP and the display module DM, and the support parts SP1 and SP2 and the charging part SAP which are disposed under the support plate MP.

In an embodiment, the support plate MP may be disposed under the display module DM. The support plate MP may include a folding support portion FA-MP and non-folding support portions NFA1-MP and NFA2-MP. Meanwhile, in this specification, the folding support portion FA-MP may be referred to as a folding portion, and the non-folding support portions NFA1-MP and NFA2-MP may be referred to as non-folding portions. A first non-folding portion NFA1-MP and a second non-folding portion NFA2-MP of the support plate MP may be spaced apart from each other with the folding portion FA-MP therebetween. The folding portion FA-MP may be a portion corresponding to the folding region FA, and the non-folding portions NFA1-MP and NFA2-MP may be portions corresponding to the non-folding regions NFA1 and NFA2, respectively.

In an embodiment, the support plate MP may include a metal material or a polymer material. For example, the support plate MP may be formed by containing stainless steel, aluminum, or an alloy thereof. In addition, unlike this, the support plate MP may be formed of carbon fiber reinforced plastic (CFRP), and the like. However, an embodiment of the invention is not limited thereto, and the support plate MP may include at least one of a non-metallic material, plastic, glass fiber reinforced plastic, or glass.

A plurality of openings OP′ may be defined in the support plate MP. The openings OP′ may be defined to correspond to the folding region FA.

The module protective layer PF may be disposed between the display module DM and the support plate MP. The module protective layer PF may be a layer disposed under the display module DM to protect a rear surface of the display module DM. The module protective layer PF may overlap the entire display module DM. The module protective layer PF may include a polymer material. For example, the module protective layer PF may be a polyimide film or a polyethylene terephthalate film. However, this is an example, and the material of the module protective layer PF is not limited thereto.

The display device ED according to an embodiment may include the support parts SP1 and SP2, and the charging part SAP. The support parts SP1 and SP2 may be parts overlapping most regions of the display module DM. The charging part SAP may be disposed outside the support parts SP1 and SP2, and may be a part overlapping an outer edge of the display module DM.

The support parts SP1 and SP2 may include a first sub-support part SP1 and a second sub-support part SP2 which are spaced apart from each other in a first direction DR1. The first sub-support part SP1 and the second sub-support part SP2 may be spaced apart from each other at a part corresponding to the folding axis FX1 (see FIG. 1B). Since the support parts SP1 and SP2 are spaced apart from each other in the folding region FA to be provided as the first sub-support part SP1 and the second sub-support part SP2, a folding or bending property of the display device ED may be improved. Meanwhile, although not illustrated, the lower module LM may further include a cushion layer (not illustrated) which is stacked on top of or under the support parts SP1 and SP2. The cushion layer (not illustrated) may include sub-cushion layers which are separated from each other at a part corresponding to the folding axis FX1 (see FIG. 1B). A lower adhesive layer, in which adhesion of a portion corresponding to the folding region FA is smaller than adhesion of portions corresponding to the non-folding regions NFA1 and NF2, may be further disposed between the support parts SP1 and SP2 and the cushion layer (not illustrated).

The cushion layer (not illustrated) may prevent a pressed phenomenon and deformation of the support plate MP due to an external impact and force. The cushion layer (not illustrated) may include elastomer such as a sponge, a foam, or a urethane resin. In addition, the cushion layer (not illustrated) may be formed by containing at least one of an acrylate-based polymer, a urethane-based polymer, a silicone-based polymer, or an imide-based polymer. However, an embodiment of the invention is not limited thereto, and the cushion layer (not illustrated) may be disposed under the support plate MP or under a lower support plate (not illustrated).

The charging part SAP may be disposed outside the support parts SP1 and SP2. The charging part SAP may be disposed between the support plate MP and the housing HAU. The charging part SAP may fill the space between the support plate MP and the housing HAU, and may fix the support plate MP.

The display device ED according to an embodiment may include the buffer layer CPN in the lower module LM. The buffer layer CPN may serve as a thickness compensation layer for compensating for a thickness under the display module DM, or as a support layer for supporting the display module DM. Meanwhile, unlike what is illustrated, the buffer layer CPN may be omitted in an embodiment.

In the display device ED according to an embodiment, a combination of the components included in the lower module LM is not limited to the components illustrated or described herein, and the combination may vary depending on the size and shape of the display device ED, operation properties of the display device ED, or the like. For example, the lower module LM may further include a component such as an additional support plate, a cushion member, and an adhesive layer.

In the display device ED according to an embodiment, the lower module LM may include at least one of upper adhesive layers AP-U1 and AP-U2 disposed on/over the support plate MP, and at least one lower adhesive layer AP-D disposed under the support plate MP.

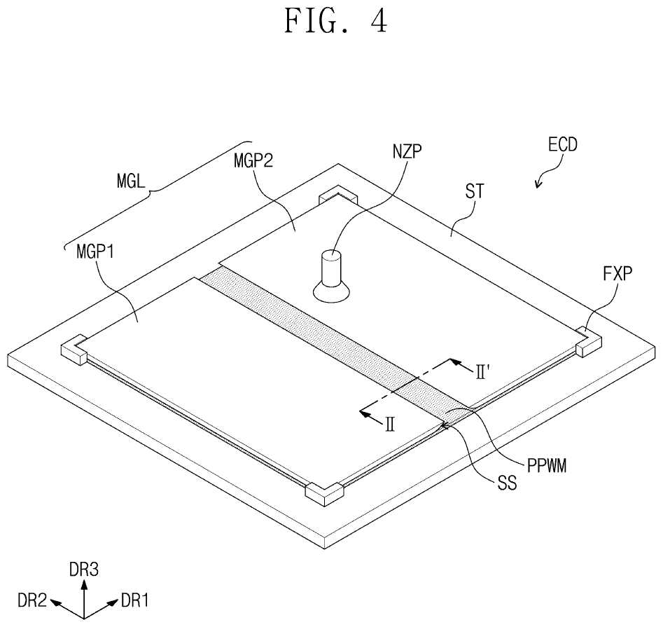

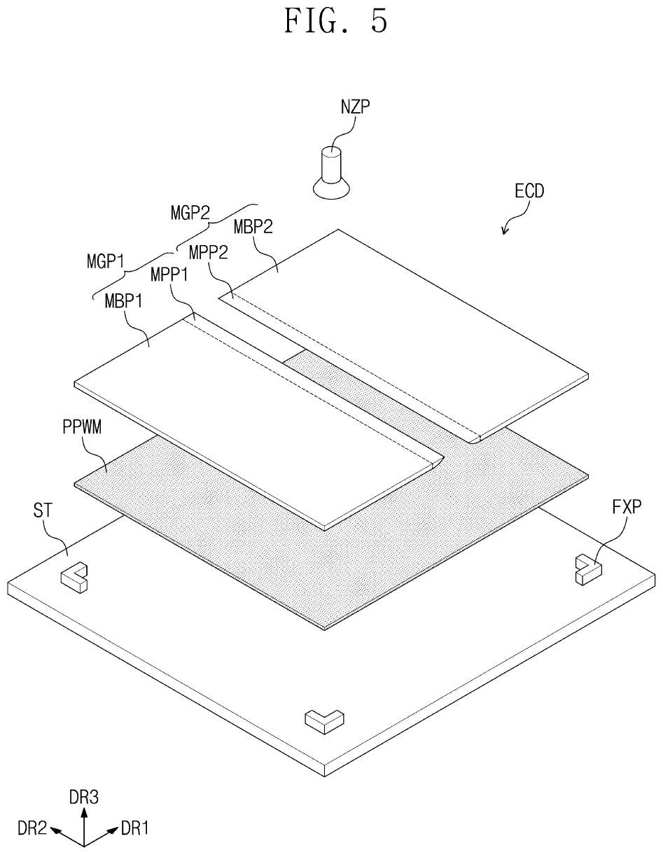

FIG. 4 is a perspective view of an etching device according to an embodiment of the invention. FIG. 5 is an exploded perspective view of the etching device of FIG. 4.

Referring to FIGS. 4 and 5 together, an etching device ECD according to an embodiment of the invention includes a stage ST, a nozzle part NZP, and a magnetic layer MGL.

A target substrate PPWM is disposed on the stage ST. The stage ST may provide a base surface to which the target substrate PPWM is fixed. The etching device ECD according to an embodiment may further include a fixing part FXP which is disposed on the stage ST and fixes the target substrate PPWM. The fixing part FXP may be provided in plurality. FIGS. 4 and 5 illustrate an embodiment in which four fixing parts FXP are provided. Corners of the target substrate PPWM may adhere to and be fixed to the fixing parts FXP. The stage ST may include a magnetic material. The magnetic material may include iron or chrome. For example, the stage ST may include stainless steel. Unlike what is illustrated in FIGS. 4 and 5, the stage ST may be large enough for a plurality of target substrates PPWM to be disposed.

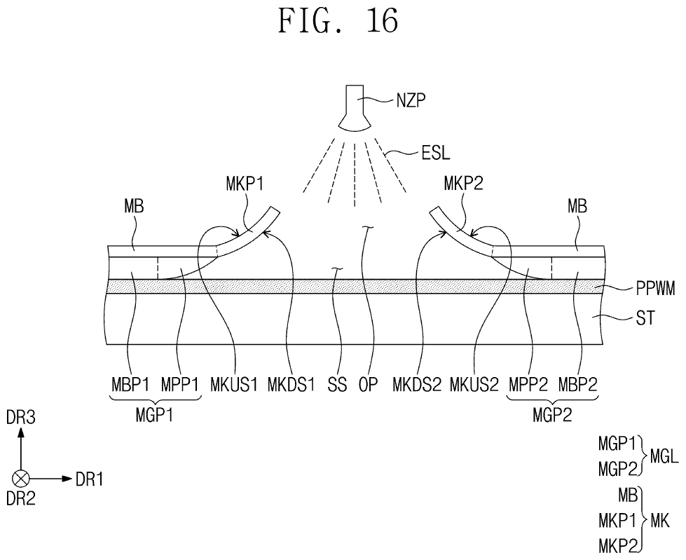

The nozzle part NZP is opposed to the stage ST with the target substrate PPWM therebetween, and sprays an etching solution ESL (see FIG. 16) toward the stage ST. The nozzle part NZP may move in a second direction DR2 or in a direction opposite to the second direction DR2. The nozzle part NZP may be provided in plurality.

The magnetic layer MGL is disposed between the target substrate PPWM and the nozzle part NZP. A portion of the magnetic layer MGL may be directly disposed on the target substrate PPWM. The magnetic layer MGL includes a magnetic material. The magnetic layer MGL may include a rubber magnet. Magnetic attractive force may be formed between the magnetic layer MGL and the stage ST, and thus the target substrate PPWM, which is disposed between the magnetic layer MGL and the stage ST, may tightly adhere to the magnetic layer MGL and the stage ST due to the magnetic attractive force. When the magnetic layer MGL and the target substrate PPWM tightly adhere to each other due to the magnetic attractive force, the etching solution ESL (see FIG. 16) may be prevented from being provided to a region in which the magnetic layer MGL is in contact with the target substrate PPWM, thereby precisely etching the target substrate PPWM.

The magnetic layer MGL includes a first magnetic part MGP1 and a second magnetic part MGP2 which are spaced apart from each other along a first direction DR1.

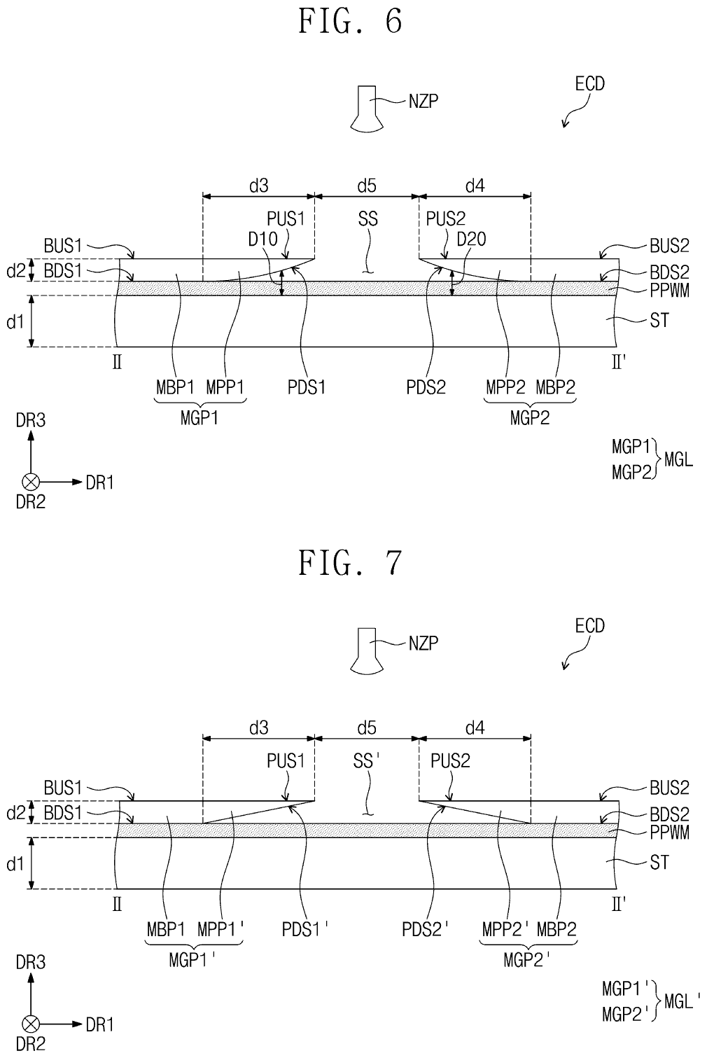

The first magnetic part MGP1 includes a first base portion MBP1 and a first protruding portion MPP1. The first base portion MBP1 is adjacent to the stage ST. The first base portion MBP1 may be directly disposed on the target substrate PPWM. A corner of the first base portion MBP1 may adhere to the fixing part FXP. The first base portion MBP1 may include a magnetic material. Magnetic attractive force may be formed between the first base portion MBP1 and the stage ST, and thus the first base portion MBP1 and a portion of the target substrate PPWM may tightly adhere to each other due to the magnetic attractive force. The first protruding portion MPP1 extends from the first base portion MBP1 in the first direction DR1 and is spaced apart from the stage ST. A shape of the first protruding portion MPP1 will be described in detail with reference to FIGS. 6 and 7.

The second magnetic part MGP2 is spaced apart from the first magnetic part MGP1 in the first direction DR1. The second magnetic part MGP2 may be spaced apart from the first magnetic part MGP1 with a spaced part SS therebetween. The second magnetic part includes a second base portion MBP2 and a second protruding portion MPP2. The second base portion MBP2 is adjacent to the stage ST. The second base portion MBP2 may be directly disposed on the target substrate PPWM. A corner of the second base portion MBP2 may adhere to the fixing part FXP. The second base portion MBP2 may include a magnetic material. Magnetic attractive force may be formed between the second base portion MBP2 and the stage ST, and thus the second base portion MBP2 and a portion of the target substrate PPWM may tightly adhere to each other due to the magnetic attractive force. The second protruding portion MPP2 extends from the second base portion MBP2 in a direction opposite to the first direction DR1 and is spaced apart from the stage ST. A shape of the second protruding portion MPP2 will be described in detail with reference to FIGS. 6 and 7.

FIGS. 6 and 7 are each a cross-sectional view of an etching device taken along line II-II′ of FIG. 4. A magnetic layer MGL in FIG. 7 has a different shape compared to that in FIG. 6. A description of the components that have been described with reference to FIGS. 4 and 5 will be omitted.

Referring to FIG. 6, a stage ST may have a thickness d1 of about 0.5 mm to about 6 mm. For example, the thickness d1 of the stage ST may be about 3 mm. A first base portion MBP1 may include a first base lower surface BDS1 adjacent to the stage ST and a first base upper surface BUS1 opposed to the first base lower surface BDS1. The first base lower surface BDS1 may be in contact with a target substrate PPWM. A magnetic layer MGL may have a thickness d2 of about 0.5 mm to about 6 mm. For example, the thickness d2 of the magnetic layer MGL may be about 0.7 mm. The thickness d2 of the magnetic layer MGL may be substantially the same as a thickness of the first base portion MBP1 or a thickness of a second base portion MBP2.

A distance D10 from the stage ST (e.g., upper surface of the stage) to a first protruding portion MPP1 (e.g., a first protruding lower surface PDS1) in a third direction DR3 progressively increases in a first direction DR1. In this specification, the third direction DR3 may be described as a thickness direction of the etching device (e.g., stage ST). The first protruding portion MPP1 may include a first protruding upper surface PUS1 and the first protruding lower surface PDS1. The first protruding upper surface PUS1 may be a surface extending from the first base upper surface BUS1 in the first direction DR1. The first protruding lower surface PDS1 may be a surface that connects the first base lower surface BDS1 and the first protruding upper surface PUS1. When viewed from a second direction DR2, the first protruding portion MPP1 may include an inclined lower surface in which a slope of a tangent line progressively increases in the first direction DR1. A width d3 of the first protruding portion MPP1 in the first direction DR1 may be substantially the same as a width of the first protruding upper surface PUS1 in the first direction DR1. The width d3 of the first protruding portion MPP1 in the first direction DR1 may be about 3 mm to about 10 mm. For example, the width d3 of the first protruding portion MPP1 in the first direction DR1 may be about 6.5 mm.

The second base portion MBP2 may include a second base lower surface BDS2 adjacent to the stage ST and a second base upper surface BUS2 opposed to the second base lower surface BDS2. A distance D20 from the stage ST (e.g., upper surface of the stage) to a second protruding portion MPP2 (e.g., a second protruding lower surface PDS2) in the thickness direction DR3 of the etching device ECD progressively increases in a direction opposite to the first direction DR1.

The second protruding portion MPP2 may include a second protruding upper surface PUS2 and the second protruding lower surface PDS2. The second protruding upper surface PUS2 may be a surface extending from the second base upper surface BUS2 in the direction opposite to the first direction DR1. The second protruding lower surface PDS2 may be a surface that connects the second base lower surface BDS2 and the second protruding upper surface PUS2. When viewed from the second direction DR2, the second protruding portion MPP2 may include an inclined lower surface in which a slope of a tangent line progressively increases in the direction opposite to the first direction DR1. At least one of the first protruding portion MPP1 or the second protruding portion MPP2 may include an inclined lower surface in which a slope of a tangent line progressively increases in the first direction DR1, when viewed from the second direction DR2. A width d4 of the second protruding portion MPP2 in the first direction DR1 may be substantially the same as a width of the second protruding upper surface PUS2 in the first direction DR1. The width d4 of the second protruding portion MPP2 in the first direction DR1 may be about 3 mm to about 10 mm. For example, the width d4 of the second protruding portion MPP2 in the first direction DR1 may be about 6.5 mm. In an embodiment, the width d3 of the first protruding portion MPP1 in the first direction DR1 may be substantially the same as the width d4 of the second protruding portion MPP2 in the first direction DR1.

A spaced distance d5 (hereinafter, a magnetic part spaced distance) between a first magnetic part MGP1 and a second magnetic part MGP2 in the first direction DR1 may be about 5 mm to about 15 mm. For example, the magnetic part spaced distance d5 may be about 9.6 mm. The magnetic part spaced distance d5 may be substantially the same as a spaced distance between the first protruding portion MPP1 and the second protruding portion MPP2 in the first direction DR1.

A width of a spaced part SS in the first direction DR1 may become greater toward the target substrate PPWM, and may become smaller farther away from the target substrate PPWM in the third direction DR3. The width of the spaced part SS may be greater than or equal to the magnetic part spaced distance d5, and may be smaller than or equal to a sum of the width d3 of the first protruding portion MPP1, the width d4 of the second protruding portion MPP2, and the magnetic part spaced distance d5.

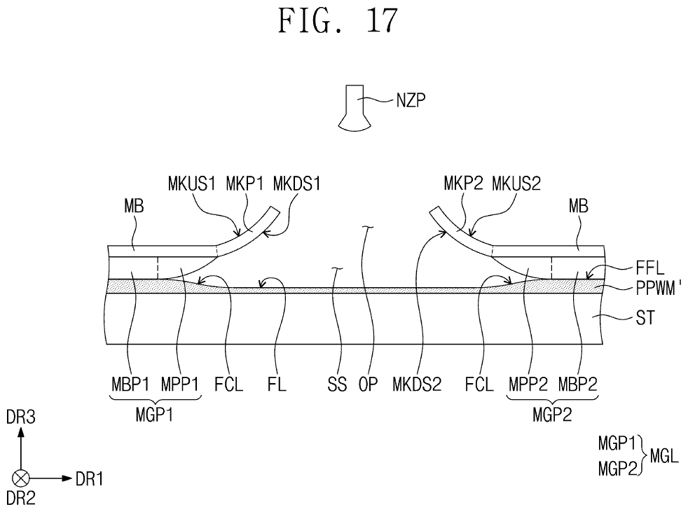

In an embodiment, the distance D10 from the stage ST (e.g., upper surface of the stage) to the first protruding portion MPP1 (e.g., the first protruding lower surface PDS1) in the thickness direction (i.e., third direction DR3) progressively increases in the first direction DR1, and the distance D20 from the stage ST (e.g., upper surface of the stage) to the second protruding portion MPP2 (e.g., the second protruding lower surface PDS2) in the thickness direction of the etching device ESD progressively increases in the direction opposite to the first direction DR1, thereby making it possible to adjust a flow rate of an etching solution ESL (see FIG. 16) provided from a nozzle part NZP. Specifically, since the etching solution ESL (see FIG. 16) is provided onto the target substrate PPWM through the spaced part SS, and the flow rate of the etching solution ESL (see FIG. 16) is relatively high in a region, of the spaced part SS, overlapping the nozzle part NZP, so that an etching rate of the target substrate PPWM is high. Since the etching solution ESL (see FIG. 16) should be provided from the nozzle part NZP through a curved path rather than a straight-line path in regions, of the spaced part SS, overlapping the first protruding portion MPP1 and the second protruding portion MPP2, respectively, the flow rate of the etching solution ESL (see FIG. 16) is relatively low, so that an etching rate of the target substrate PPWM is low. Due to this difference, as illustrated in FIG. 17, a boundary between an inclined surface FCL and a flat surface FL may be formed to be gentle, thereby mitigating a distortion phenomenon that would occur between the display region DP-DA (see FIG. 2) and the non-display region DP-NDA (see FIG. 2) of the display device ED (see FIG. 2).

Referring to FIG. 7, in an embodiment, at least one of a first protruding lower surface PDS1′ or a second protruding lower surface PDS2′ may include an inclined surface with a constant slope when viewed from the second direction DR2. A first protruding portion MPP1′ included in a first magnetic part MGP1′ and a second protruding portion MPP2′ included in a second magnetic part MGP2′ may each include a triangular shape when viewed from the second direction DR2.

As described with reference to FIG. 6, a space in which the first magnetic part MGP1′ and the second magnetic part MGP2′ are spaced apart from each other in the first direction DR1 may be defined as a spaced part SS′. The description of the spaced part SS in FIG. 6 will be similarly applied to a description of the spaced part SS′.

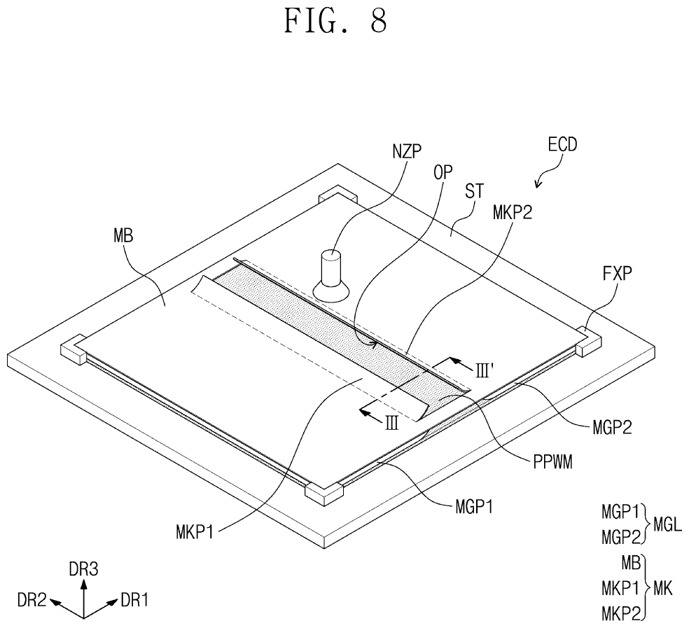

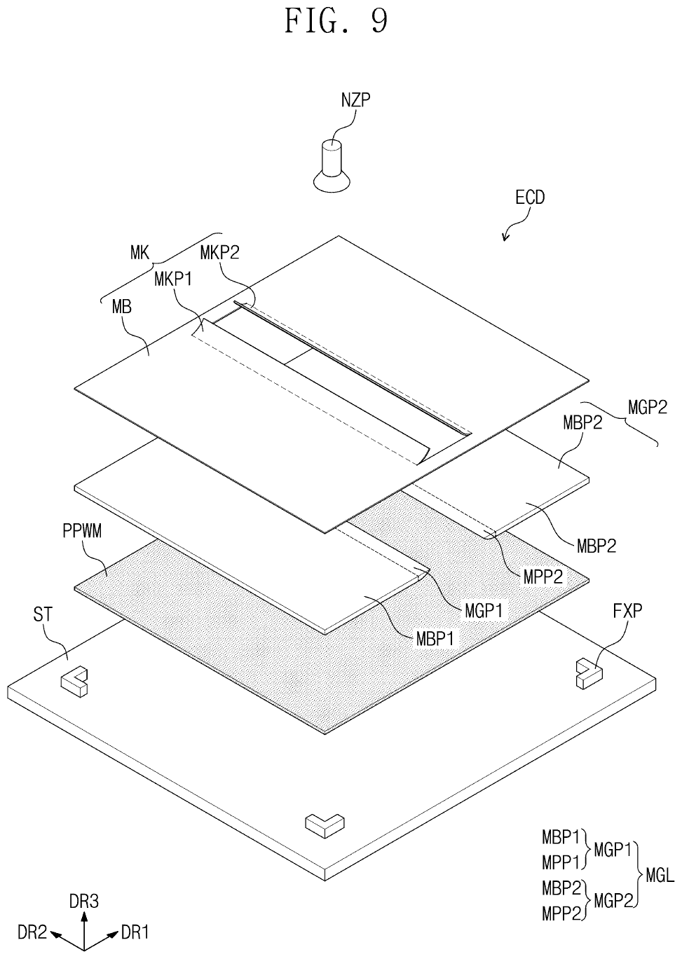

FIG. 8 is a perspective view of an etching device according to an embodiment of the invention. FIG. 9 is an exploded perspective view of the etching device of FIG. 8. An etching device ECD illustrated in each of FIGS. 8 and 9 further includes a mask MK unlike the etching device ECD illustrated in each of FIGS. 4 and 5. A description of the components that have been described with reference to FIGS. 4 to 7 will be omitted, and differences thereof will be mainly described.

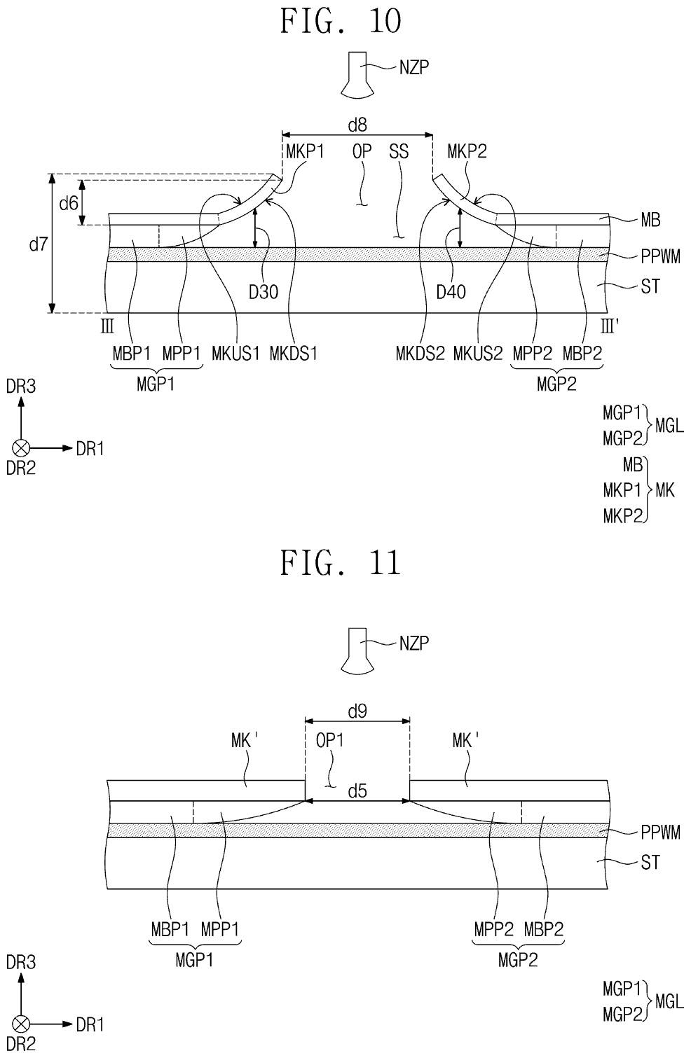

The etching device ECD may further include the mask MK. The mask MK may be disposed between a magnetic layer MGL and a nozzle part NZP. The mask MK may be directly disposed on the magnetic layer MGL. Corners of the mask MK may adhere to a fixing part FXP. An opening OP may be defined in the mask MK. The opening OP may overlap the nozzle part NZP in the thickness direction. The mask MK may include a magnetic material. The mask MK may contain iron and chrome. The mask MK may include a mask base MB, a first mask portion MKP1, and a second mask portion MKP2. A detailed description of the first mask portion MKP1 and the second mask portion MKP2 will be described in detail with reference to FIG. 10.

FIG. 10 is a cross-sectional view of an etching device taken along line III-III′ of FIG. 8.

Referring to FIG. 10, a mask base MB may be directly disposed on a magnetic layer MGL. A first mask portion MKP1 may be a portion extending from the mask base MB. The first mask portion MKP1 may not overlap the magnetic layer MGL in the thickness direction. A distance D30 from the stage ST (e.g., upper surface of the stage) to the first mask portion MKP1 (e.g., a first mask lower surface MKDS1) in a third direction DR3 may progressively increase in a first direction DR1. The first mask portion MKP1 may include a first mask upper surface MKUS1 and the first mask lower surface MKDS1. The first mask upper surface MKUS1 may be a surface extending from an upper surface of the mask base MB. The first mask upper surface MKUS1 may have a downward convex shape when viewed from a second direction DR2. When viewed from the second direction DR2, the first mask upper surface MKUS1 may have a curved shape in which a slope of a tangent line progressively increases in the first direction DR1. The first mask lower surface MKDS1 may be a surface extending from a lower surface of the mask base MB. The first mask lower surface MKDS1 may have a downward convex shape when viewed from the second direction DR2. When viewed from the second direction DR2, the first mask lower surface MKDS1 may have a curved shape in which a slope of a tangent line progressively increases in the first direction DR1.

A difference between a maximum spaced distance and a minimum spaced distance, among spaced distances D30 between the first mask portion MKP1 and the stage ST in the third direction DR3, may be about 0.5 mm to about 3 mm. For example, the difference between the maximum spaced distance and the minimum spaced distance, among the spaced distances D30 between the first mask portion MKP1 and the stage ST in the third direction DR3, may be about 0.7 mm. A maximum distance d6 in the third direction DR3 from a surface parallel to the lower surface of the mask base MB to the first mask lower surface MKDS1 may be about 0.5 mm to about 6 mm. For example, the maximum distance d6 may be about 0.7 mm. A maximum distance d7 in the third direction DR3 from a lower surface of the stage ST to the first mask upper surface MKUS1 may be about 1.5 mm to about 18 mm. For example, the maximum distance d7 may be about 3.1 mm.

A second mask portion MKP2 may be a portion extending from the mask base MB. The second mask portion MKP2 may not overlap the magnetic layer MGL in the thickness direction. A distance D40 from the stage ST (e.g., upper surface of the stage) to the second mask portion MKP2 (e.g., a second mask lower surface MKDS2) in the third direction DR3 may progressively increase in a direction opposite to the first direction DR1. The second mask portion MKP2 may include a second mask upper surface MKUS2 and the second mask lower surface MKDS2. The second mask upper surface MKUS2 may be a surface extending from the upper surface of the mask base MB. The second mask upper surface MKUS2 may have a downward convex shape when viewed from the second direction DR2. When viewed from the second direction DR2, the second mask upper surface MKUS2 may have a curved shape in which a slope of a tangent line progressively increases in the direction opposite to the first direction DR1. The second mask lower surface MKDS2 may be a surface extending from the lower surface of the mask base MB. The second mask lower surface MKDS2 may have a downward convex shape when viewed from the second direction DR2. When viewed from the second direction DR2, the second mask lower surface MKDS2 may have a curved shape in which a slope of a tangent line progressively increases in the direction opposite to the first direction DR1.

A difference between a maximum spaced distance and a minimum spaced distance, among spaced distances D40 between the second mask portion MKP2 and the stage ST in the third direction DR3, may be about 0.5 mm to about 3 mm. For example, the difference between the maximum spaced distance and the minimum spaced distance, among the spaced distances D40 between the second mask portion MKP2 and the stage ST in the third direction DR3, may be about 0.7 mm.

A spaced distance d8 between the first mask portion MKP1 and the second mask portion MKP2 in the first direction DR1 may be about 5 mm to about 15 mm. For example, the spaced distance d8 between the first mask portion MKP1 and the second mask portion MKP2 in the first direction DR1 may be about 9.6 mm.

FIG. 11 is a cross-sectional view of an etching device according to an embodiment of the invention.

Referring to FIG. 11, in an embodiment, one end of a mask MK′ may be aligned with one end of a first protruding portion MPP1 or one end of a second protruding portion MPP2. A width d9 of an opening OP1 in a first direction DR1 may be substantially the same as a spaced distance d5 between a first magnetic part MGP1 and a second magnetic part MGP2 in the first direction DR1. The width d9 of the opening OP1 in the first direction DR1 may be about 5 mm to about 15 mm. For example, the width d9 of the opening OP1 in the first direction DR1 may be about 9.6 mm.

When the one end of the mask MK′ is aligned with the one end of the first protruding portion MPP1 or the one end of the second protruding portion MPP2, gravitational force applied to each of the first protruding portion MPP1 and the second protruding portion MPP2 and magnetic attractive force with the stage ST may be offset due to magnetic attractive force between the first protruding portion MPP1 and the mask MK′ and magnetic attractive force between the second protruding portion MPP2 and the mask MK′, and therefore a sagging-down phenomenon of the first protruding portion MPP1 and the second protruding portion MPP2 may be alleviated.

Hereinafter, a window manufacturing method by using the aforementioned etching device according to an embodiment of the invention will be described, and a detailed description of the components that have been described with reference to FIGS. 1A to 11 will be omitted.

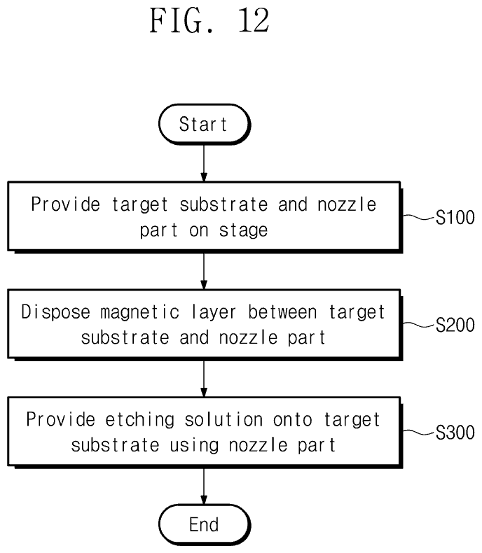

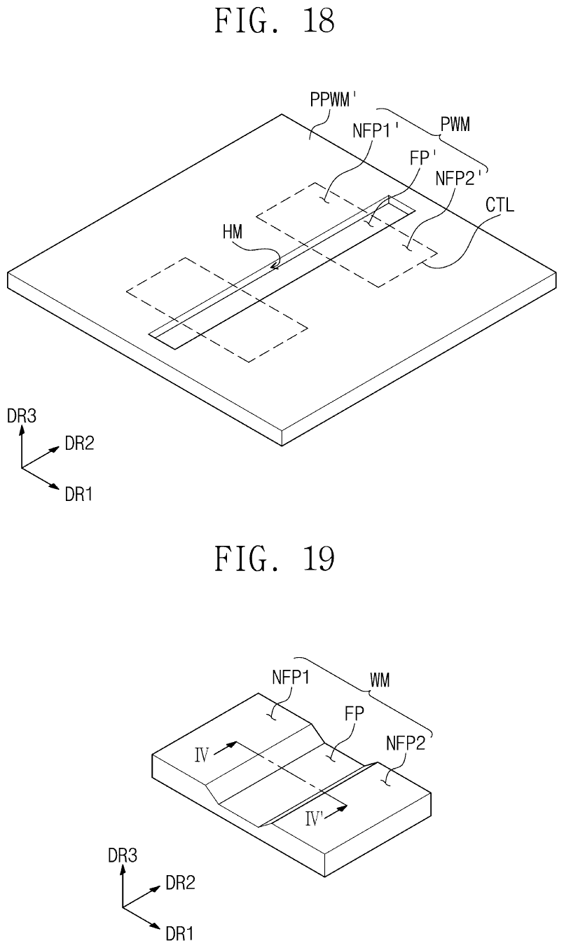

FIG. 12 is a flowchart of a window manufacturing method according to an embodiment of the invention. FIGS. 13 to 17 each illustrate a part of a window manufacturing method according to an embodiment of the invention. FIG. 18 is a perspective view of a target substrate according to an embodiment of the invention. A target substrate PPWM′ illustrated in in FIG. 18 is obtained by forming a groove HM in a target substrate PPWM (see FIG. 13) through etching with the etching device according to the invention.

Referring to FIG. 12, a window manufacturing method according to an embodiment of the invention includes a step of providing a target substrate and a nozzle part on a stage (S100), a step of disposing a magnetic layer between the target substrate and the nozzle part (S200), and a step of providing an etching solution onto the target substrate using the nozzle part (S300).

Referring to FIG. 13, in the step of providing the target substrate PPWM and the nozzle part NZP on the stage ST, the target substrate PPWM may be directly disposed on the stage ST. Although not illustrated, the stage ST may include the fixing part FXP (see FIG. 4), and corners of the target substrate PPWM may adhere to the fixing part FXP (see FIG. 4) to be fixed onto the stage ST. The nozzle part NZP may be opposed to the stage ST with the target substrate PPWM therebetween.

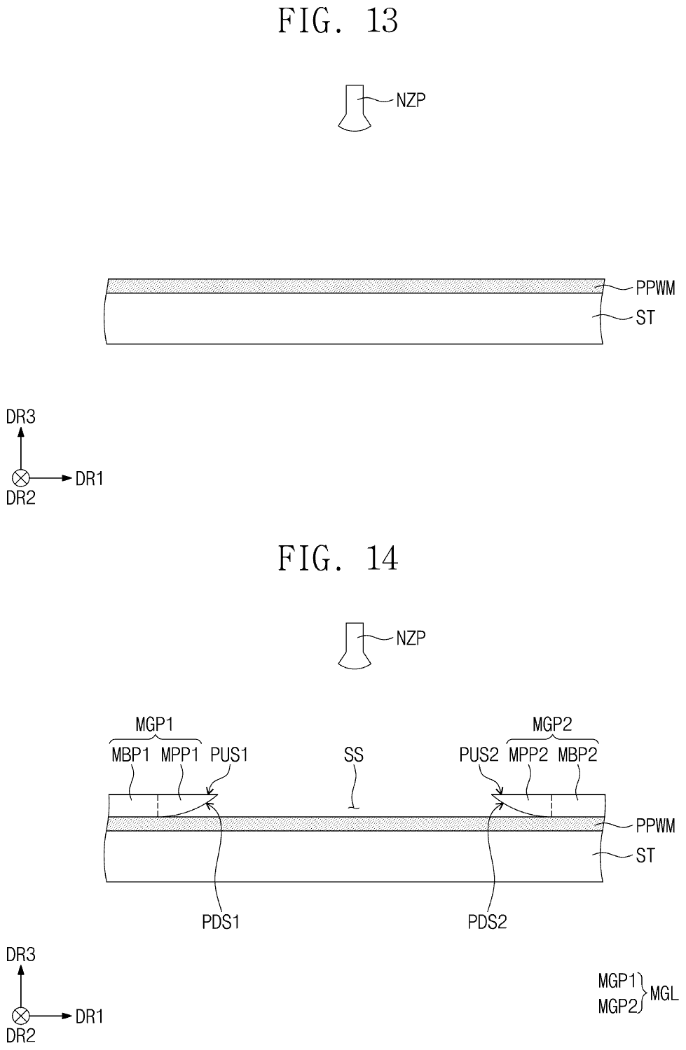

Referring to FIG. 14, in the step of disposing a magnetic layer MGL between the target substrate PPWM and the nozzle part NZP, the magnetic layer MGL may be directly disposed on the target substrate PPWM. A first base portion MBP1 and a second base portion MBP2 may each be directly disposed on the target substrate PPWM. The stage ST and the magnetic layer MGL may each include a magnetic material, and the target substrate PPWM may adhere to each of the magnetic layer MGL and the stage ST due to magnetic attractive force that is formed between the magnetic layer MGL and the stage ST.

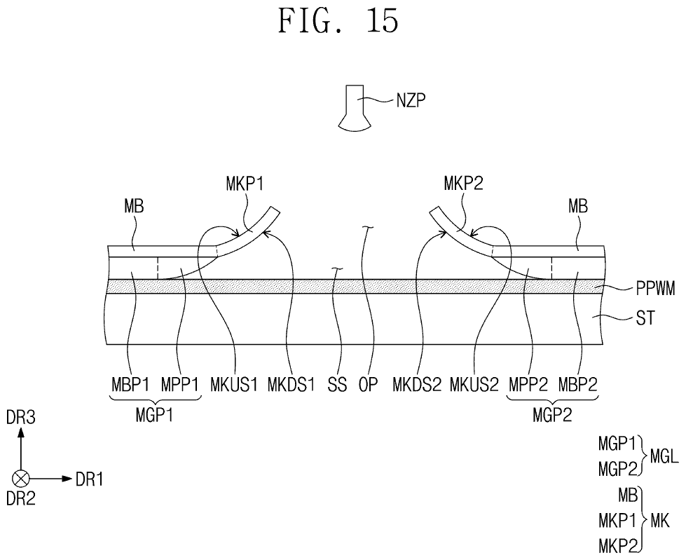

Referring to FIG. 15, the window manufacturing method according to an embodiment may further include a step of disposing, between the magnetic layer MGL and the nozzle part NZP, a mask MK in which an opening OP overlapping the nozzle part NZP in the thickness direction is defined. The mask MK may include a magnetic material. The mask MK may be directly disposed on the magnetic layer MGL in the step of disposing the mask MK between the magnetic layer MGL and the nozzle part NZP. The opening OP and a spaced part SS may overlap each other in the thickness direction. The nozzle part NZP may overlap the opening OP.

Referring to FIG. 16, in the step of providing the etching solution ESL onto the target substrate PPWM using the nozzle part NZP, the etching solution ESL may be provided onto the target substrate PPWM through the opening OP and the spaced part SS. The etching solution ESL may include a fluorine-containing compound. The etching solution ESL may include hydrogen fluoride. The mask MK, the magnetic layer MGL, and the stage ST may include a material that is not dissolved in the etching solution ESL.

A flow rate of the etching solution ESL may become slower, within the opening OP, in a first direction DR1 or in a direction opposite to the first direction DR1 with respect to the center of the opening OP. The flow rate of the etching solution ESL may become slower, within the spaced part SS, in the first direction DR1 or in the direction opposite to the first direction DR1 with respect to the center of the spaced part SS. Since the etching solution ESL should be provided from the nozzle part NZP through a curved path rather than a straight-line path in regions, of the spaced part SS, overlapping a first protruding portion MPP1 and a second protruding portion MPP2, respectively, the flow rate of the etching solution ESL is relatively lower than in a case of being provided straightly so that an etching rate of the target substrate PPWM becomes lower. Due to this difference, as illustrated in FIG. 17, a boundary between an inclined surface FCL and a flat surface FL may be formed to be gentle, thereby mitigating a distortion phenomenon that would occur between the display region DP-DA (see FIG. 2) and the non-display region DP-NDA (see FIG. 2) of the display device ED (see FIG. 2) when a window WM (see FIG. 19) formed through the window manufacturing method according to an embodiment is applied to the display device ED (see FIG. 2).

Referring to FIGS. 17 and 18 together, the etching solution ESL may etch a portion of the target substrate PPWM and thus a target substrate PPWM′ having a groove HM formed in an upper surface thereof may be formed. The groove HM may be defined by the flat surface FL and the inclined surface FCL. The flat surface FL may be a surface parallel to the first direction DR1. The inclined surface FCL may be a surface that connects the flat surface FL and an unetched upper surface of the target substrate PPWM′. The boundary between the flat surface FL and the inclined surface FCL may be formed curvedly, thereby improving the reliability of a display device.

The target substrate PPWM′ formed through the window manufacturing method according to the invention may include a preliminary window PWM having a first preliminary non-folding portion NFP1′, a preliminary folding portion FP′, and a second preliminary non-folding portion NFP2′. It is exemplarily illustrated that the number of preliminary windows PWM is two, but the number of preliminary windows may be more than two, or less than two. For example, the target substrate PPWM′ may include eight preliminary windows PWM. The preliminary window PWM may be distinguished from the rest portion of the target substrate PPWM′ on the basis of a cutting line CTL.

FIG. 19 is a perspective view of a window according to an embodiment of the invention. FIG. 20 is a cross-sectional view of a window taken along line IV-IV′ of FIG. 19. FIG. 19 illustrates a window WM which is formed by cutting the target substrate PPWM′ illustrated in FIG. 18 along the cutting line CTL.

Referring to FIGS. 19 and 20 together, the window manufacturing method according to an embodiment may further include a step of forming the window WM by cutting along the cutting line CTL (see FIG. 18). The window WM may include a first non-folding portion NFP1, a folding portion FP, and a second non-folding portion NFP2. A groove HM′ may be defined in the window WM. The groove HM′ may be defined by a flat surface FL and an inclined surface ICL. An angle AG between the inclined surface ICL and a virtual plane including the flat surface FL may be about 0.4 degrees to about 1.6 degrees. For example, the angle AG may be about 0.4 degrees.

A width FLL of the flat surface FL in a first direction DR1 may be about 5 mm to about 15 mm. For example, the width FLL of the flat surface FL in the first direction DR1 may be about 9 mm. A width SL of the inclined surface ICL in the first direction DR1 may be about 3 mm to about 10 mm. A sum FAL of the width FLL of the flat surface FL in the first direction DR1 and the width SL of the inclined surface ICL in the first direction DR1 may be greater than about 15 mm and less than or equal to about 30 mm. An etched depth EDL may be defined as step heights between the flat surface FL and the non-folding portions NFP1 and NFP2. The etched depth EDL may be about 40 micrometers to about 175 micrometers.

A window manufacturing method using an etching device according to the invention includes a step of providing a target substrate and a nozzle part on a stage, a step of disposing a magnetic layer between the target substate and the nozzle part, and a step of providing an etching solution onto the target substrate using the nozzle part. The magnetic layer includes a first magnetic part having a first protruding portion and a second magnetic part having a second protruding portion. A distance from the stage to the first protruding portion in a thickness direction progressively increases in a first direction, and a distance from the stage to the second protruding portion in the thickness direction progressively increases in a direction opposite to the first direction. In the window manufacturing method according to the invention, since an etching solution should be provided from a nozzle part through a curved path rather than a straight-line path in regions, of a spaced part, overlapping the first protruding portion and the second protruding portion, respectively, a flow rate of the etching solution is relatively lower than in a case of being provided straightly, so that an etching rate of the target substrate becomes lower. This difference may make a boundary between an inclined surface and a flat surface formed to be gentle, thereby mitigating a distortion phenomenon that would occur between a display region and a non-display region of a display device.

An etching device according to the invention makes it possible to manufacture a window with foldable properties and improved reliability through a simple process by using a magnetic layer that includes a reverse taper shape.

In addition, a window manufacturing method according to the invention makes it possible to manufacture a window with foldable properties and improved reliability through a simple process by using an etching device that includes a magnetic layer having a reverse taper shape, and therefore process difficulty may be reduced.

In the above, description has been made with reference to embodiments, but those skilled in the art or those of ordinary skill in the relevant technical field may understand that various modifications and changes may be made to the invention within the scope not departing from the spirit and the technology scope of the invention described in the claims to be described later. Therefore, the technical scope of the invention is not limited to the contents described in the detailed description of the specification, but should be determined by the claims.

What is claimed is:

1. An etching device comprising:
a stage on which a target substrate is disposed;
a nozzle part opposed to the stage with the target substrate therebetween, and configured to spray an etching solution toward the stage; and
a magnetic layer disposed between the target substrate and the nozzle part, and including a first magnetic part and a second magnetic part spaced apart from the first magnetic part in a first direction,
wherein the first magnetic part includes a first base portion adjacent to the stage and a first protruding portion extending from the first base portion in the first direction and spaced apart from the stage,
the second magnetic part includes a second base portion adjacent to the stage and a second protruding portion extending from the second base portion in a direction opposite to the first direction and spaced apart from the stage,
a distance from the stage to the first protruding portion in a thickness direction of the etching device progressively increases in the first direction, and
a distance from the stage to the second protruding portion in the thickness direction progressively increases in the direction opposite to the first direction.

2. The etching device of claim 1, further comprising a fixing part disposed on the stage and configured to fix the target substrate.

3. The etching device of claim 1, wherein the stage comprises a magnetic material.

4. The etching device of claim 1, wherein the etching solution comprises a fluorine-containing compound.

5. The etching device of claim 1, wherein the magnetic layer comprises a rubber magnet.

6. The etching device of claim 1, wherein the stage and the magnetic layer each independently have a thickness of about 0.5 millimeters (mm) to about 6 mm.

7. The etching device of claim 1, wherein a spaced distance between the first magnetic part and the second magnetic part in the first direction is about 5 mm to about 15 mm.

8. The etching device of claim 1, wherein a width of the first protruding portion in the first direction and a width of the second protruding portion in the first direction are each independently about 3 mm to about 10 mm.

9. The etching device of claim 1, wherein the first base portion comprises a first base lower surface adjacent to the stage and a first base upper surface opposed to the first base lower surface,
the first protruding portion comprises a first protruding upper surface extending from the first base upper surface in the first direction and a first protruding lower surface connecting the first base lower surface and the first protruding upper surface,
the second base portion comprises a second base lower surface adjacent to the stage and a second base upper surface opposed to the second base lower surface, and
the second protruding portion comprises a second protruding upper surface extending from the second base upper surface in the direction opposite to the first direction and a second protruding lower surface connecting the second base lower surface and the second protruding upper surface.

10. The etching device of claim 9, wherein at least one of the first protruding lower surface or the second protruding lower surface has a downward convex shape when viewed in a second direction crossing the first direction and the thickness direction.

11. The etching device of claim 9, wherein at least one of the first protruding lower surface or the second protruding lower surface has a straight line shape when viewed in a second direction crossing the first direction and the thickness direction.

12. The etching device of claim 1, further comprising a mask which is disposed between the magnetic layer and the nozzle part, and in which an opening overlapping the nozzle part in the thickness direction is defined.

13. The etching device of claim 12, wherein the mask comprises a magnetic material.

14. The etching device of claim 12, wherein a width of the opening in the first direction is substantially the same as a spaced distance between the first magnetic part and the second magnetic part in the first direction.

15. The etching device of claim 12, wherein the mask comprises:
a first mask portion to which a distance from the stage in the thickness direction progressively increases in the first direction; and
a second mask portion which is spaced apart from the first mask portion in the first direction with the opening therebetween and to which a distance from the stage in the thickness direction progressively increases in the direction opposite to the first direction,
wherein each of the first mask portion and the second mask portion does not overlapping the magnetic layer in the thickness direction.

16. The etching device of claim 15, wherein a difference between a maximum spaced distance and a minimum spaced distance, among the spaced distances between the first mask portion and the stage in the thickness direction, is about 0.5 mm to about 3 mm, and
a difference between a maximum spaced distance and a minimum spaced distance, among the spaced distances between the second mask portion and the stage in the thickness direction, is about 0.5 mm to about 3 mm.

17. A window manufacturing method comprising:
providing a target substrate on a stage and providing a nozzle part opposed to the stage with the target substrate therebetween;
disposing, between the target substrate and the nozzle part, a magnetic layer including a first magnetic part and a second magnetic part spaced apart from the first magnetic part in a first direction; and
providing, by using the nozzle part, an etching solution onto the target substrate through a spaced part defined as a space between the first magnetic part and the second magnetic part,
wherein the first magnetic part includes a first base portion disposed on the target substrate and a first protruding portion extending from the first base portion in the first direction and spaced apart from the stage,
the second magnetic part includes a second base portion disposed on the target substrate and a second protruding portion extending from the second base portion in a direction opposite to the first direction and spaced apart from the stage,
a distance from the stage to the first protruding portion in a thickness direction of the stage progressively increases in the first direction, and
a distance from the stage to the second protruding portion in the thickness direction progressively increases in the direction opposite to the first direction.

18. The window manufacturing method of claim 17, wherein the first base portion and the second base portion are each directly disposed on the target substrate.

19. The window manufacturing method of claim 17, further comprising, between the disposing of the magnetic layer and the providing of the etching solution onto the target substrate, disposing, between the magnetic layer and the nozzle part, a mask in which an opening overlapping the nozzle part in the thickness direction is defined.

20. The window manufacturing method of claim 19, wherein the stage and the mask each comprise a magnetic material.
